(19) United States
(12) Patent Application Publication
(10) Pub. No.: US 2013/0160055 A1
(43) Pub. Date: Jun. 20, 2013

(54) DISTRIBUTED PROCESSING FOR INTERACTIVE VIDEO

(71) Applicant: HAPPY CLOUD INC., Cambridge, MA (US)

(72) Inventors: Gavriel RAANAN, Beit Shemesh (IL); Lawrence REISLER, Beit Shemesh (IL); Jacob GUEDALIA, Newton, MA (US); Isaac David GUEDALIA, Beit Shemesh (IL)

(73) Assignee: HAPPY CLOUD INC., Cambridge, MA (US)

(21) Appl. No.: 13/766,795

(22) Filed: Feb. 14, 2013

Related U.S. Application Data
(63) Continuation of application No. 12/688,943, filed on Jan. 18, 2010.
(60) Provisional application No. 61/145,568, filed on Jan. 18, 2009.
(60) Provisional application No. 61/257,119, filed on Nov. 2, 2009.

(51) Int. Cl. H04N 21/472

(52) U.S. Cl. CPC H04N 21/47202
USPC 725/38

(57) ABSTRACT

Processing interactive software supporting video, including a first computer configured to execute an interactive process and display a video stream response, where the interactive process responds to an external input by generating a control signal and sending the control signal, a remote console configured to receive the control signal and send the video stream response where the video stream response is computed by the remote console, and a hardware interface configured to convert the control signal from a first format to a second format and to convert the video stream response from the second format to the first format where the first computer sends the control signal and receives the video stream response in the first format and where the remote console receives the control signal and sends the video stream response in the second format.

### CROSS-REFERENCE TO RELATED APPLICATIONS

This application is a continuation of U.S. patent application Ser. No. 12/688,943, filed Jan. 18, 2010, which claims priority benefit of U.S. Provisional Patent Application No. 61/145,568, filed Jan. 18, 2009, and U.S. Provisional Patent Application No. 61/257,119, filed Nov. 2, 2009, all of which are incorporated herein by reference in their entirety.

### FIELD OF THE INVENTION

The invention relates to distributive computing in general, and more particularly to processing both video and control signals over a distributive architecture.

### BACKGROUND OF THE INVENTION

When using interactive software with video, such as playing interactive games with a console such as an XBOX or WII, the proprietary hardware unit, or console, must be purchased in addition to the games which are then installed on the game console. Since the games are in the possession of the user, they can be illegally copied and distributed. It would be advantageous to a) not have to buy the hardware unit, and b)not be able to copy the game. See FIG. 1 for the prior art. A controller 100 receives input from a user such as by pressing buttons or by manipulating a joy stick. Controller 100 sends the control signals corresponding to the user input to game console 102. Game console 102 interprets the control signal and sends corresponding video images to display 104. The 3 hardware devices are connected via cables: controller to console, and console to display.

Alternative to using a game console, one can download a game from a server. In such a configuration, the heavy processing takes place on the user's computer, including video streaming. This occupies valuable resources such as hard disk memory, computation requirements, and RAM. Additionally, there is still the danger that the game can be illegally copied and distributed.

Additionally, games can be played for various user-specified resolutions. When downloading a game from a server that delivers rendered video, the graphics are typically designed for a specific screen size or resolution. Changing to a user-specified resolution can be complicated.

### SUMMARY OF THE INVENTION

In one aspect of the invention a system is provided for processing interactive software supporting video, the system including a first computer configured to execute an interactive process and display a video stream response, where the interactive process responds to an external input by generating a control signal and sending the control signal, a remote console configured to receive the control signal and send the video stream response where the video stream response is computed by the remote console, and a hardware interface configured to convert the control signal from a first format to a second format and to convert the video stream response from the second format to the first format where the first computer sends the control signal and receives the video stream response in the first format and where the remote console receives the control signal and sends the video stream response in the second format.

In another aspect of the invention the remote console is included in a second computer.

In another aspect of the invention the hardware interface is included in the second computer.

In another aspect of the invention the video stream response is formatted in a polygon rendering format.

In another aspect of the invention a method is provided for processing interactive software supporting video, the method including executing an interactive process and displaying a video stream response on a first computer, where the interactive process responds to an external input by generating a control signal and sending the control signal, receiving the control signal, computing the video stream response, sending the video stream response, and converting the control signal from a first format to a second format and converting the video stream response from a second format to a first format where the conversion steps are performed by a hardware interface, and where the first computer sends the control signal and receives the video stream response in the first format and where the remote console receives the control signal and sends the video stream response in the second format, where the receiving, computing and sending steps are performed at a remote console, and where the sending and the receiving steps between the hardware interface and the computer are performed over a network.

In another aspect of the invention the remote console is included in a second computer.

In another aspect of the invention the hardware interface is included in the second computer.

In another aspect of the invention the video stream response is formatted in a polygon rendering format.

### BRIEF DESCRIPTION OF THE DRAWINGS

The invention will be understood and appreciated more fully from the following detailed description taken in conjunction with the appended drawings in which:

FIG. 1 is a simplified conceptual illustration of the prior art.

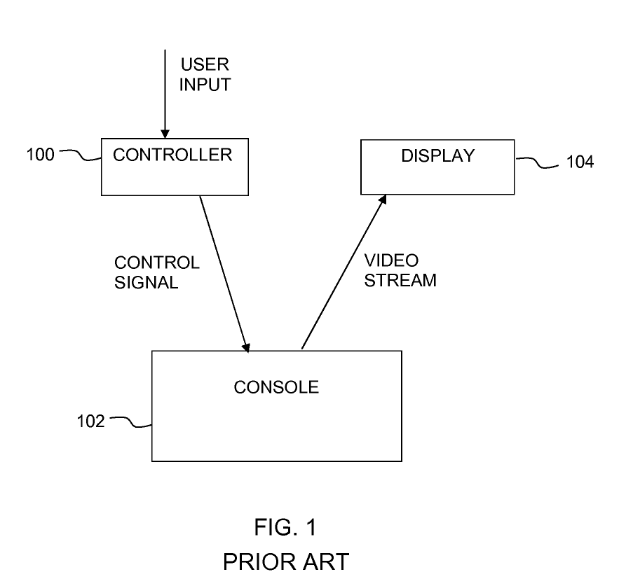

FIG. 2A is a simplified conceptual illustration of distributive processing system supporting interactive video, constructed and operative in accordance with an embodiment of the present invention;

FIG. 2B is a simplified conceptual illustration of distributive processing system supporting interactive video, constructed and operative in accordance with another embodiment of the present invention;

FIG. 2C is a simplified conceptual illustration of distributive processing system supporting interactive video, constructed and operative in accordance with another embodiment of the present invention.

### DETAILED DESCRIPTION OF THE INVENTION

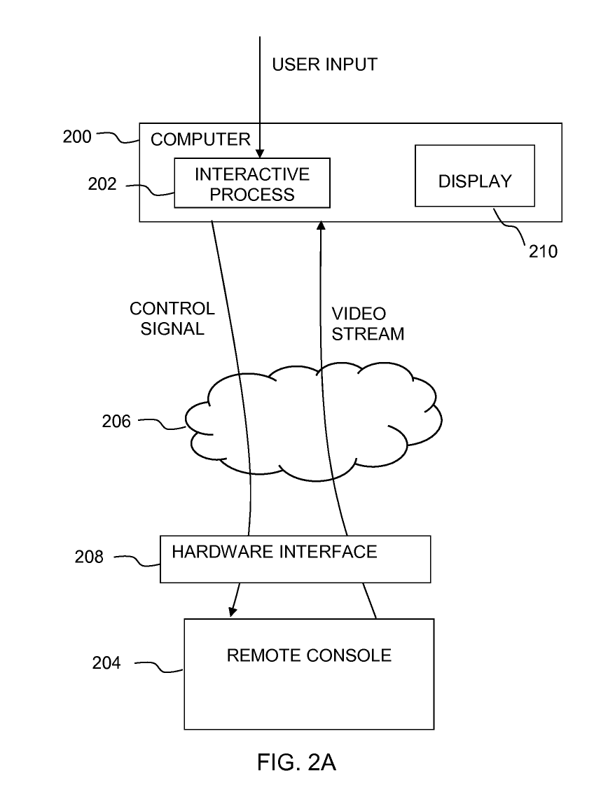

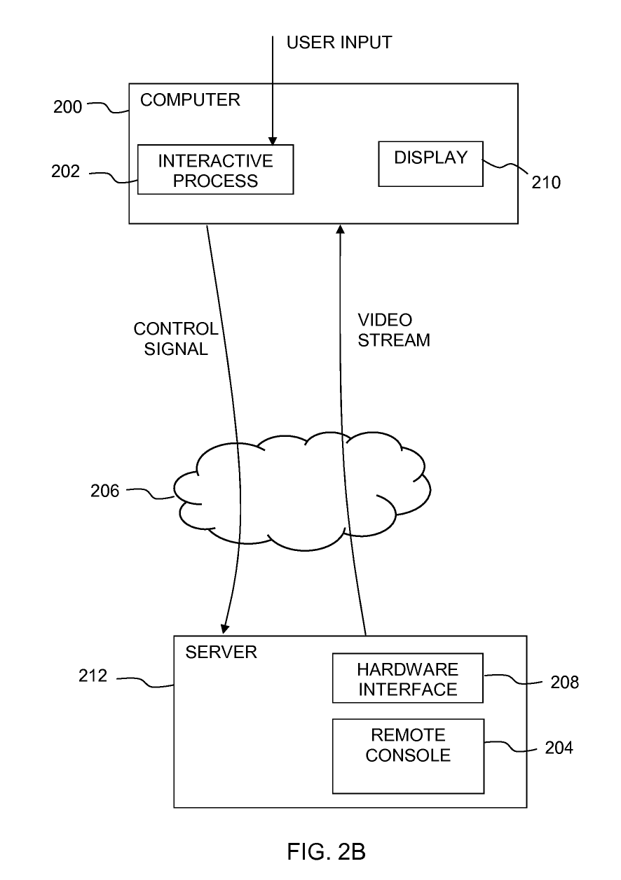

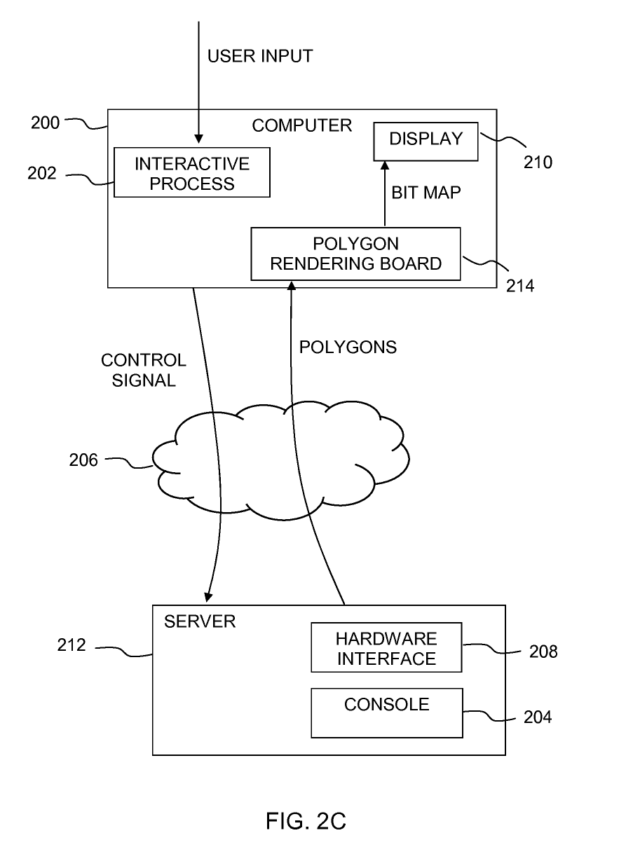

Reference is now made to FIG. 2A which is a simplified conceptual illustration of a system for distributive processing supporting interactive video over a network, constructed and operative in accordance with an embodiment of the invention. In the system of FIG. 2A, a computer 200 running interactive process 202 receives a user input. Computer 200 sends a corresponding control signal to a remote console 204, such as an XBOX, via network 206 and hardware interface 208, which converts the control signal from a format allowing for network transmission, such as the Internet Protocol (IP) to a signal type that remote console 204 is configured to receive, such as an analog signal, or a multiplexed signal. It is noted that prior to sending the corresponding control signal, computer 200 may be required to log in to remote console 204. Remote console 204 interprets the control signal and sends a corresponding video response to computer 200 via network 206 and hardware interface 208, which converts the control signal to a format that is transmittable over network 206. Computer 200 receives and displays the video response on display 210 using conventional methods.

Reference is now made to FIG. 2B which is a simplified conceptual illustration of a system for processing interactive software with video over a network, constructed and operative in accordance with another embodiment of the invention. The system of FIG. 2B is similar to that described in FIG. 2A with the exception that console 204 and hardware interface 208 reside within server 212. It is noted that console 204 and hardware interface may be hardware units embedded within server 212, or alternatively, server 212 may simulate the operation of hardware interface 208 and console 204 using programmable instructions. In the second scenario, where console 204 is embedded within server 212 as programmable instructions, one or more instances of console 204 may be operational simultaneously, allowing one or more users to simultaneously interact with console 204.

Reference is now made to FIG. 2C which is a simplified conceptual illustration of a system for processing interactive software with video over a network, constructed and operative in accordance with another embodiment of the invention. The system of FIG. 2C is similar to that described in FIGS. 2A and 2B with the exception that server 212 sends the video response in polygon format. Computer 200 receives the polygon formatted video response and renders the video response using conventional techniques via polygon rendering board 214 to generate a bit map which is displayed on display 210.

It is noted that by locating the console executing an interactive software at a remote location and enabling a user to log in to the software over a network connection, the user may interact with the software via an ordinary computer while still enjoying a high level video response, thus avoiding the need to purchase an additional piece of hardware. Additionally, as the interactive software resides at a remote location, the user cannot copy the software. And finally, by using the standard polygon rendering hardware which is present on most computers to render the images on the user side, one can simplify the process of scaling the video response to a user specification, as well as reduce the hardware requirements on the server side.

While the methods and apparatus herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A system for processing interactive software supporting video, the system comprising:
a computer configured to
execute an interactive process,
receive a user input in the context of the interactive process,
send, from the computer to a remote console via a computer network, a control signal corresponding to the user input,
receive, via the computer network, a video response in a polygon format,
render the video response from the polygon format, thereby generating a bit map, and
display the bit map generated from the video stream response; and
a remote console configured to
receive the control signal via the computer network,
interpret the control signal, and
send the video stream response in the polygon format to the computer via the computer network.

2. A method for processing interactive software supporting video, the method comprising:
executing an interactive process at a computer;
receiving a user input in the context of the interactive process;
sending, from the computer to a remote console via a computer network, a control signal corresponding to the user input, thereby causing the remote console to
interpret the control signal, and
send a video stream response in a polygon format to the computer via the computer network;
receiving the video response via the computer network;
rendering the video response from the polygon format, thereby generating a bit map; and
displaying the bit map generated from the video stream response.
